(19) United States
(12) Patent Application Publication
(10) Pub. No.: US 2017/0138417 A1
(43) Pub. Date: May 18, 2017

(54) ACTUATOR WHICH CAN BE DRIVE-COUPLED AND HAS A VARIABLE DISPLACEMENT PUMP

(71) Applicant: Schaeffler Technologies AG & Co. KG, Herzogenaurach (DE)

(72) Inventors: Dominik Herkommer, Schriesheim (DE); Markus Baehr, Buhl (DE); Marco Grethel, Buhlertal (DE)

(73) Assignee: Schaeffler Technologies AG & Co. KG, Herzogenaurach (DE)

(21) Appl. No.: 15/127,572

(22) PCT Filed: Feb. 26, 2015
(86) PCT No.: PCT/DE2015/200106

§ 371 Date: Sep. 20, 2016

(30) Foreign Application Priority Data
Mar. 24, 2014 (DE) 10 2014 205 439.7

(51) Int. Cl. F16D 48/02; F16H 61/30

(52) U.S. Cl. CPC F16D 48/02; F16H 61/30; F16D 2048/0248; F16D 2048/0221

(57) ABSTRACT

The invention relates to an actuating device for actuating a clutch and/or a transmission of a motor vehicle, including a pump having two fluid connections and including a movable actuating element fluidically connected to a first fluid connection of the pump, wherein the pump is designed such that in a first pump position, in which the pump is driven in a first direction of rotation, for extending the actuating element the pump conveys a pressure fluid in a first conveying direction from a second fluid connection to the first fluid connection, wherein the pump is configured as a variable displacement pump which is reversible with regard to the conveying direction of the pump, wherein the pump is designed such that after it has been moved into a second pump position, in which the pump is driven in the first direction of rotation, for retracting the actuating element the pump conveys a pressure fluid in a second conveying direction, opposite the first conveying direction, from the first fluid connection to the second fluid connection. The invention further relates to a clutch and to a transmission system having such an actuating device.

### BACKGROUND

The invention relates to an actuating device/actuator for operating a clutch and/or a transmission of a motor vehicle, such as a passenger car, truck, bus, or agricultural utility vehicle, comprising a pump having two fluid connections, and comprising a displaceable actuating element, connected to a first fluid connection of the pump in a fluid-conducting fashion, with the pump being designed such that in a first pump setting, in which it is driven in a first direction of rotation for extending the actuating element, it conveys a pressure fluid in a first conveying direction from a second fluid connection to the first fluid connection. The invention also includes a clutch with such an actuating device and a transmission arrangement (for example a duplex clutch transmission) comprising such an actuating device.

Respective actuating devices in clutches/clutch device are already known in prior art. For example, DE 10 2005 014 633 A1 discloses a clutch and a clutch actuator as well as a method for operating at least one clutch in a drive train of a motor vehicle. The clutch actuator comprises an electromotive actuating drive and a displacement arrangement, by which a rotary motion of the actuator drive can be converted into a translational displacement motion of a displacer for moving the clutch, with here the displacer (displacing arrangement) comprising a belt drive, which has an exterior part and an interior part, and the actuator drive for the displacer being formed by an electric motor, with the exterior part of the belt drive being connected to the crankshaft of the internal combustion engine and the internal part of the belt drive to the rotor of the electric motor.

EP 1 236 918 B1 also discloses a clutch system, which includes a clutch device, particularly for the arrangement in a drive train between a drive unit and a transmission. The clutch system also includes an actuating device for actuating the clutch device in a hydraulic fashion, using at least one hydraulic slave cylinder of the clutch device, with the actuating device comprising a hydraulic medium—storage device to render available hydraulic medium for an adjustable pressure level, by the slave cylinder determining the actuator status of the clutch device. The hydraulic medium—storage device further comprises a hydraulic medium—pump arrangement, which can be influenced with regards to the output pressure and/or conveyance rate and/or conveyance direction, with the hydraulic medium—pump arrangement being arranged and implemented such that by influencing the hydraulic medium—pump arrangement the pressure level and thus the actuating status can be adjusted.

Therefore, it is already known in general to obtain the energy required for actuating the clutch from the drive train itself. Clutch systems of prior art however primarily use an electromotive actuation, with the actuating energy required for moving/adjusting the actuating piston being generated in an electromotive fashion. However it is also known from such electronic clutches that the actuating energy to be applied for the electromotive actuation must be generated and transmitted via relatively costly motors and their control electronic. Furthermore, the energy for such motors is initially taken from the drive train via the alternator, stored in the battery, and then taken from there. The energy required for actuating the clutch is therefore initially converted expensively into electric energy via generators or external pumps in the drive train. Here, major loss develops and all components in this chain must be sized appropriately large.

The electromotive systems of prior art therefore show the disadvantage that usually several electric motors are required and must be controlled. The motors are expensive, require structural space, and are subject to strong price fluctuations.

In clutches of prior art, in which the actuating energy is generated hydraulically, it is generally common to use pumps; however when using the pumps in the known systems here frequently relatively large power loss develops, since the pumps are always located in the drive train. Although the loss can be partially reduced by interphase transformers or a bypass, the systems of prior art are then frequently embodied in a relatively complex version. The hydraulic systems of prior art can therefore exhibit quite high power loss and complicated valve circuitry.

### SUMMARY

The objective of the present invention is to correct the disadvantages known from prior art and to provide a clutch arrangement by which the effectiveness of the generation of actuating energy is increased and additionally the number of installed components is reduced.

This is attained according to the invention in that the pump is embodied as a displacement pump, reversible with regards to its conveying direction, with the displacement pump being embodied such that after the adjustment into a second pump setting, in which it is driven via the pump drive shaft rotating in a first direction of rotation for engaging the actuating piston, a pressure fluid conveys in a second conveying direction, opposite the first conveying direction, from the first fluid connection to the second fluid connection.

This way, a drive unit is provided allowing to directly take the actuating energy for actuating the clutch from the drive train/the internal combustion engine, without any intermediate conversion into another form of energy, for example electric energy. Preferably, in order to supply energy, the displacement pump/reversible displacement pump, with its conveying volume being adjusted by a force-controlled actuator and one or more sensor pistons (particularly when in the downstream arrangements pressure difference—sensor pistons are used), is directly coupled to the drive such that the pressure adjusts proportionally to the target signal. The energy conversion required in electric systems as well as the conversion loss connected thereto is avoided. This way, the effectiveness of the clutch actuation is considerably increased. The energy for clutch operation is obtained via the pump directly from the drive train itself, to the extent possible, and fed to the actuating piston. In particular, these advantages are further amplified when using this (these) pump(s) for actuating clutches and/or transmissions of an automatic transmission system or a parallel conventional transmission.

Additional advantageous embodiments are claimed in the dependent claims and in the following explained in greater detail.

According to another embodiment it is advantageous when a first high pressure line is provided, which connects the first fluid connection in a fluid-conducting fashion to the (first) actuator element and/or a low-pressure line is provided, which connects the first fluid connection and/or the second fluid connection in a fluid-conducting fashion to a retention system, for example a reservoir. This way the design of the clutch actuating device is further simplified. Then, for generating or releasing pressure at the respective fluid connector, depending on the pump setting, here the pressure fluid only needs to be pumped back and forth between the fluid connections.

In this context it is also advantageous if a preferably force-controlled actuator is provided to change the pump setting. The actuator is arranged such that, depending on the adjustment force applied, preferably generated electrically, the pump is switched back and forth between the first pump setting and the second pump setting. This way a particularly effective adjustment of the pump is possible. Accordingly the conveying volume of the pump per rotation is adjustable/adjusted.

It is also beneficial for the first high-pressure line to be connected in a fluid-conducting fashion to a first sensor piston, automatically returning the pump into a neutral position at a certain pressure value, with the pump in the neutral position being adjusted such that a pressure value in the first high-pressure line is kept constant. The neutral position is preferably embodied as the zero position of the pump, in which the pump is adjusted such that it conveys no pressure fluid, neither in the first conveying direction nor in the second conveying direction. This way, the adjustment of the pump and the control of the (first) actuating element are further simplified.

Additionally it is advantageous if an actuator is provided, which adjust the pump setting of the pump in a force-controlled fashion (adjusting the volume flow and the pressure of the pump), which together with the first sensor piston and/or with the second sensor piston acts in an adjusting fashion upon the pump such that the pump setting is dependent on the forces, applied upon the pump in an adjusting fashion by the actuator, the first sensor piston, and/or the second sensor piston. This way, a simple adjustment and inversion of the displacement pump is possible by an actuating force, acting upon the actuator, being simply increased or reduced depending on the desired pump setting. The respective sensor piston or the two sensor pistons then act upon the pump displacement according to a mechanical proportional controller, initially caused by the change of the actuating force of the actuator. When a displacement force is generated by the respective (first and/or second) sensor piston, this displacement force acts upon the pump in an adjusting fashion such that this displacement force (of the respective sensor piston) tries to adjust the respectively other pump setting and thus the other conveying direction. Here, the neutral position is reached at equilibrium of the moment generated by the displacement forces of the actuator, the first sensor piston, and/or the second sensor piston.

When a second high-pressure line is provided, which connects in a fluid-conducting fashion the second fluid connection to another second actuating element, two actuating elements can be controlled by one pump. This way, particularly duplex clutches, clutch-transmission units, or duplex clutch transmissions can be actuated by one actuating device using a pump and the functionality of the actuating device is further improved.

In this context it is also advantageous if the second high-pressure line is connected in a fluid-conducting fashion to a second sensor piston, automatically returning the pump into a neutral position at a certain pressure value, with the pump in the neutral position being adjusted such that a pressure value in the second high-pressure line is kept constant.

The neutral position is preferably once more embodied as the zero position of the pump, in which the pump is adjusted such that it conveys no pressure fluid, neither in the first conveying direction nor in the second conveying direction. This way, the displacement of the pump and the control of the (second) actuating element are further simplified. If an actuator is provided, it preferably acts respectively against the respectively first or sensor piston (depending on the pump setting) of the side impinged with pressure.

It is further advantageous if the actuating element, connected to the first fluid connection of the pump, is provided and/or embodied to actuate a clutch and the second actuating element to actuate a transmission. This way the structural space assumed by the actuating device can be utilized in a particularly effective fashion and a partial transmission of the duplex clutch transmission can be integrated in a space-saving fashion.

It is also beneficial if a two-pressure valve is provided, with a first input of the two-pressure valve being connected in a fluid-conducting fashion to the first high-pressure line, a second input of the two-pressure valve to the second high-pressure line, and an output of the two—pressure valve to the low-pressure line. This way the design of the actuating device is further simplified.

If in an operating state using a motor shaft the pump drive shaft can be driven via a mechanical connection, for example a pair of gears, a chain drive, or a belt drive, the actuating device can be directly driven, further improving the effectiveness.

It is also advantageous for a clutch to be equipped with an actuating device according to one of the above-described embodiments, with the actuating element connected to the first fluid connection of the pump being provided for engaging and disengaging the clutch. The clutch/clutch device may here be embodied as a duplex clutch, with preferably a separate pump being provided for each partial clutch, which pump in turn being embodied as the above-mentioned displacement pump. Alternatively the clutch may also be embodied as a single clutch.

It is also possible to equip a transmission arrangement/clutch-transmission unit, preferably embodied as a duplex clutch transmission, with an actuating device according to one of the above-described embodiments. Here, preferably one displacement pump is provided for each partial transmission, which in turn is provided with two actuating elements, with the first actuating element being provided to engage and disengage a clutch and the second actuating element being provided for activating and releasing a transmission stage.

In other words, with the present invention an actuator/actuating device is suggested with a reversing pump (displacement pump). The reversing pump can be directly connected to the drive train. It is necessary that it can be adjusted by a conveying volume of “0” (zero position). Then two reversing pumps/displacement pumps can be used for a duplex clutch. The actuator with the reversing pump can also be used both for actuating the clutch as well as the transmission.

### BRIEF DESCRIPTION OF THE DRAWINGS

The invention is now explained in greater detail using the figures, in the context of which various embodiments are illustrated. Shown are:

FIG. 1 a schematic illustration of a drive train of a motor vehicle, comprising an actuating device according to the invention in a first embodiment, with the actuating device being provided to engage and disengage a clutch,

FIG. 2 a schematic illustration of a drive train of a motor vehicle comprising an actuating device according to the invention in a second embodiment, with the actuating device being provided to engage and disengage a clutch as well as to actuate a transmission,

FIG. 3 a schematic illustration of a drive train of a motor vehicle comprising an actuating device according to the invention in a third embodiment with the actuating device comprising two pumps and each pump being provided for engaging and disengaging a clutch/partial clutch of a duplex clutch as well as for actuating a partial transmission, and

FIG. 4 a schematic illustration of a drive train of a motor vehicle, comprising an actuating device according to the invention in a fourth embodiment, with the actuating device being embodied similar to the actuating device shown in FIG. 3, and also showing two pumps, however unlike in FIG. 3, here the pumps being arranged in the axial direction at the same height and off-set along the circumference, but arranged side-by-side in the axial direction.

### DETAILED DESCRIPTION OF THE PREFERRED EMBODIMENTS

The figures are only of a schematic nature and merely serve for understanding the invention. Identical elements are provided with the same reference characters.

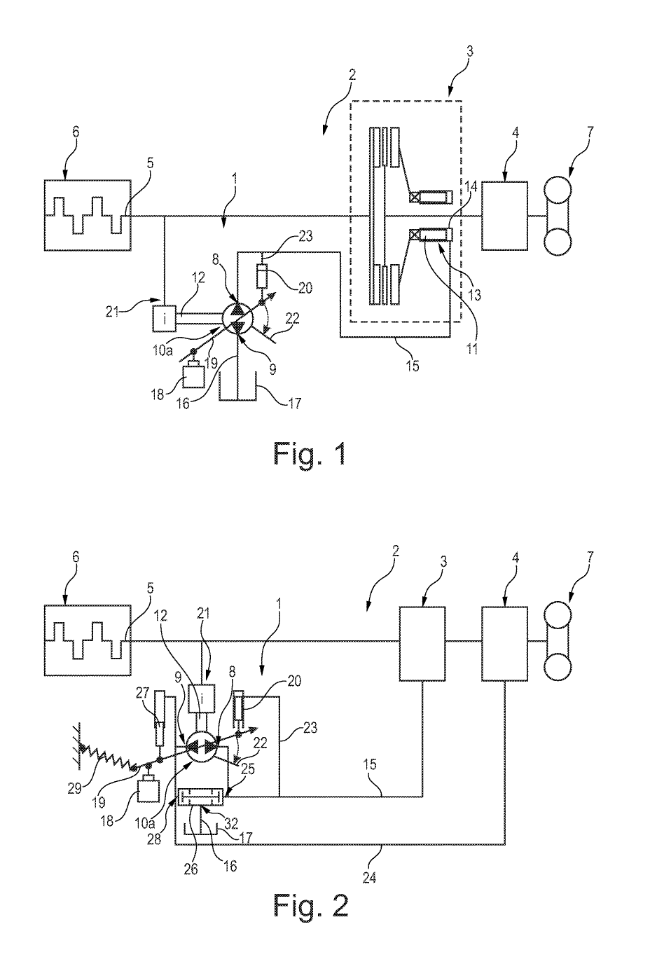

FIGS. 1 to 4 are four embodiments of the actuating device 1 according to the invention in a drive train 2 of a motor vehicle, such as a passenger vehicle, truck, bus, or agricultural utility vehicle. The actuating device 1 is generally provided for actuating a clutch 3, a transmission 4, or both the clutch 3 as well as the transmission 4. The actuating device 1 serves therefore as a control element, which adjusts as a control element the clutch 3, i.e. a connection device that can be disengaged for the optional transmission of torque from a motor shaft/crankshaft 5 of an internal combustion engine 6 (diesel or gasoline motor) to the transmission 4, which transmission 4 is motion coupled to a wheel 7 or several wheels 7 of a motor vehicle, and/or the transmission 4 for changing the speed and converting the torque.

The actuating device 1 comprises a pump 10a, 10b having two fluid connections 8, 9, and a displaceable (first) actuating element 11 connected in a fluid-conducting fashion to a first fluid connection 8 of the pump 10a, 10b, with the pump 10a, 10b being designed such that it is driven in a first pump setting, in which the drive occurs in a first direction of rotation, for extending the actuating element 11, conveying a pressure fluid in a first conveying direction from a second fluid connection 9 to a first fluid connection 8. The pump 10a, 10b is embodied with regards to its conveying direction as a displacement pump 10a, 10b that can be inverted, with the displacement pump 10a, 10b being embodied such that after the adjustment into a second pump setting, in which it is driven in the first direction of rotation for retracting the actuating element 11, a pressure fluid is conveyed in a second conveying direction from the first fluid connection 8 to the second fluid connection 9, opposite the first conveying direction.

In the first exemplary embodiment shown in FIG. 1 the actuating device 1 is embodied such that it acts in a manner pushing back and forth upon a (first) actuating element 11, embodied as an actuating piston 11, for engaging and disengaging the clutch 3, embodied as a (normally disengaged) single clutch. For this purpose, the actuating piston 11 embodied as a cylindrical piston is designed as a part of a slave cylinder 13. The first fluid connection 8 is connected in a fluid-conducting fashion, here hydraulically to a cylindrical housing 14 of the slave cylinder 13. The actuating element 11, hereinafter called actuating piston 11, is supported in the cylindrical housing 14 displaceable in the axial direction (along the rotary axis of the clutch) and depending on the pressure value in the cylindrical housing 14 it is in an extended position, in which the clutch 3 is closed/engaged, or in a retracted position (as shown in FIG. 1), in which the clutch 3 is open/disengaged.

For the hydraulic connection of the slave cylinder 13 and its actuating piston 11 to the pump 10a, here a (first) high-pressure line 15 is provided, which is connected to the first fluid connection 8 and to the slave cylinder 13.

In this embodiment the second fluid connection 9 is connected to a low-pressure line 16, which in turn is hydraulically connected to a retention system 17. The retention system 17 is embodied as a separate reservoir, however for example in case of the clutch 3 being implemented as a wet-running clutch 3, it can alternatively also be embodied directly by the fluid storage chamber within the clutch housing/the clutch bell of the clutch 3.

Furthermore, a (first) actuator 18 is provided, which switches the pump 10a between the first pump setting and the second pump setting. The pump 10a, which is preferably embodied as an adjustable axial displacement pump, has an adjustment element 19 (here schematically indicated by an arrow), by which the pump setting can be adjusted. Preferably the adjustment element 19 is embodied as a swashplate 19. The adjustment element 19 is supported in a pivotal fashion in reference to the pump 10a (particularly in reference to the pump housing of the pump 10a). In one area of the adjustment element 19 in turn the actuator 18 engages in order to influence the incline of the adjustment element 19. The adjustment element 19 must be pivoted, due to a first actuating force generated by the actuator, in the first pump setting shown such that the pressure value in the high-pressure line 15 constantly increases at this point of time by conveying the pressure fluid in the first conveying direction. At another section of the adjustment element 19 additionally a (first) sensor piston 20 engages. This first sensor piston 20 is hydraulically connected to the high-pressure line 15 and serves as the control element like to a mechanical proportional controller, depending on the pressure value in the high-pressure line 15.

The first sensor piston 20 is here embodied such that upon reaching a certain pressure value in the high-pressure line 15, which is higher than the pressure value in the retracted position of the actuating piston 11, acts with a (second) actuating force (depending on the pressure value in the high-pressure line 15) in a returning fashion upon the adjustment element 19. The sensor piston 20 acts in the returning direction at every pressure greater than zero. The second adjusting force of the first sensor piston 20 acts here opposite the first adjusting force of the actuator 18 and thus the adjusting element 19 is moved back in the direction of the second conveying direction such that the adjusting element 19, upon reaching a certain pressure value in the high-pressure line, is moved back in the direction of the neutral position. This way in turn the volume flow is lowered in the first conveying direction until it is kept constant in the neutral position together with the pressure value in the first high-pressure line 15. The first and second actuating forces are here selected such that the moments acting at the adjustment element 19 are at equilibrium in this neutral position. Due to the fact that the high-pressure line 15 as well as the slave cylinder 13 have in this exemplary embodiment no leakage or only to a negligible extent, this neutral position is equivalent to a zero position of the pump 10a, at which the pump 10a is adjusted such that neither the first nor the second conveying direction shows a pressure fluid flux/any pressure fluid is conveyed.

For driving the pump 10a (in a first direction of rotation) again a pump drive shaft 12 can be driven by the motor shaft 5 at least in an operating state of the actuating device 1, allowing to connect the pump drive shaft 12 via a mechanical connection 21 to the motor shaft 5. The mechanical connection 21 has a transmission (i), which causes a conversion of the speed and torque between the motor shaft 5 and the pump drive shaft 12. The mechanical connection 21 can be embodied as a pair of gears, as a belt drive, or as a chain drive.

The pump drive shaft 12 is here preferably permanently connected to the motor shaft 5 in a torque-proof fashion and permanently drives the pump 10a. When the internal combustion engine 6 (gasoline or diesel motor) is turned on, the pump drive shaft 12 is driven in a (first) direction of rotation, predetermined by the mechanical connection 21, which leads to the fact that the pump 10a is also driven in this first direction of rotation. IF the drive train 2 is embodied for example as a hybrid drive train, the internal combustion engine 6 can however also be shut off in case of an electric operation of the vehicle, here preventing any direct drive of the pump drive shaft 12 by the motor shaft 5. In this electric operation the pump 10a is however then rotated in reference to the (stationary) pump drive shaft 12 such that still a drive of the pump 10a is possible in a first direction of rotation.

If the actuating piston 11 in turn shall be brought out of the previously described extended position into a retracted position, here the swashplate 19/the adjustment element 19 must be brought in turn into a second position beyond the neutral position, indicated by the reference arrow 22, allocated to the second pump setting. For this purpose, again the actuator 18 is adjusted by a reduction of the first adjustment force such that the pressure fluid is conveyed in the second conveying direction back into the retention system 17 and the pressure in the high-pressure line 15 drops until a minimal pressure value adjusts, which is lower than the determined pressure value and the actuating piston 11 is brought into the retracted position.

In other words, if the displacement pump 10a is embodied as an adjustable pump 10a, with allows the inversion of its conveying direction, the fluid pressure influencing the displacement position of the actuating piston 11 can be controlled depending on the pump setting. The pump setting influencing the conveying direction of the pump 10a can be changed by the actuator 18. Here, the sensor piston 20 is embodied and connected to the pressure line 43 such that, when after an appropriate movement of a tappet of the actuator 18 (by changing the exciter force of the actuator 18) the pressure value in the high-pressure line 15 is increased, the sensor piston 20 extends due to the increased pressure (first pump setting). At a certain (first) pressure value in the high-pressure line 15 therefore a horizontal readjustment (back into the neutral position/zero position) of the swashplate 19 occurs by the sensor piston 20. If after another appropriate motion of the tappet of the actuator 18 (by changing the exciter force of the actuator 18) the pressure value reduces in the high-pressure line 15 (in the second pump setting), the sensor piston 20 moves, based on the pressure value changing in the high-pressure line 15 such that at a lower pressure value in the high-pressure line 15 once more a horizontal readjustment occurs (neutral position/into the zero position) of the swash plate 19 by the sensor piston 20. This way, pressure control is converted and the actuating piston 10a can be appropriately adjusted.

The sensor piston 20 is connected via a branching/a side-channel 23 to the high-pressure line 15. In this branching 23, between the high-pressure line 15 and the sensor piston 38, here preferably a throttle is provided/integrated (not shown here for reasons of clarity), which serves as a damping element for the pressure fluctuations generated during operation by the pump piston of the pump 10a.

The actuator 18 is preferably embodied as an electromotive actuator, which can be driven via an inductive coil system. For this purpose, a receiver coil near the pump and a transmitter coil distant from the pump may be provided, with the transmitter coil driving the receiver coil via an inductive field. Alternatively, the actuator 18 can also be driven via a voice coil, similar to the drive of arms for hard drives. The drive can then comprise a stationary part and a moving part, with the moving part in turn being embodied integrally with the swashplate 19. Depending on the embodiment, at least one of the two parts represents a set of coils, the other one then one or more magnets or also a set of coils. As another alternative it is also possible to directly provide/fasten the receiver coil at the first end section of the swashplate 19 in order to directly move the swashplate 19 via an inductive force.

FIG. 2 then shows another, second embodiment of the actuating device 1 according to the invention. This actuating device 1 is essentially equivalent to the actuating device 1 according to FIG. 1, thus the technical features mentioned for the first embodiment also apply in principle for the second embodiment. As an essential difference, the pump 10a is however now connected to two high-pressure lines 15, 24 such that they can actuate/adjust both the clutch 3 as well as the transmission 4 into the two pump settings.

Similarly to the first exemplary embodiment, the first high-pressure line 15 is provided for operating the clutch 3. In addition to the connection to the slave cylinder 13 (here no longer shown for reasons of clarity) and the first fluid connection 8 of the pump 10a, the high-pressure line 15 is also hydraulically connected to a first input 25 of a two-pressure valve 26. At the second fluid connection 9 of the pump 10a in turn a second high-pressure line 24 is connected, which hydraulically connects the second fluid connection 9 to a second actuating element, for example embodied as an actuating piston, (no longer shown here for reasons of clarity). The second actuating element serves here as an actuating element for the transmission 4, for example in order to select and/or set a transmission stage. The second actuating element serves therefore to “change gears” and is supplied with energy via the second high-pressure line 24. Valve logics may also underlie the second actuating element.

The second high-pressure line 24 is also hydraulically connected to a sensor piston 27, hereinafter called second sensor piston 27. Additionally, the second sensor piston 27 engages the adjustment element 19 and in the second high-pressure line 24 it acts at a certain pressure value in a displacing fashion upon the adjustment element 19.

Additionally, the second high-pressure line 24 is hydraulically connected to a second input 28 of the two-pressure valve 26. The low-pressure line 17 is again hydraulically connected to an output 32 of the two pressure valve 26, in order to alternating connect the two inputs 25, 28 of the two-pressure valve 26 to the retention system 17.

FIG. 2 shows the first pump setting, in which the adjustment element/the swashplate 19 can be adjusted in its incline by the actuator 18 such that a pressure fluid is pumped from the second high-pressure line 24 via the second fluid connection 9 and the first fluid connection 8 into the first high-pressure line 15. Due to the fact that the pressure value initially in the second high-pressure line 24 is still greater than the pressure value in the first high-pressure line 15, at first pressure fluid is taken from the second high-pressure line 24. When the pressure value in the first high-pressure line 15 increases thereby and finally exceeds the pressure value in the second high-pressure line 24, the two-pressure valve 26 is adjusted such that the connection between the low-pressure line 16 and the first high-pressure line 15 is severed and the pressure fluid is therefore conveyed via the second high-pressure line 24 out of the retention system 17.

If the pressure value increases in the first high-pressure line 15 the second sensor piston 27 is retracted and the first sensor piston 20 is extended so that again a resetting of the adjustment element 19 occurs. Both the second sensor piston 27 and the first sensor piston 20 each generate an adjustment force at a pressure exceeding zero, which acts upon the adjustment element 19. At a certain pressure value it finally occurs again that the adjustment element 19 and/or the pump 10a is once more forced into the neutral position. This way the adjustment element 19, after reaching a certain pressure value, is returned into a neutral position in which neutral position the pressure value can be kept constant in the first high-pressure line 15. The first sensor piston 20 and the second sensor piston 27 here engage the adjustment element 19 such that the (second) adjustment force generated by the first sensor piston 20 generally urges the adjustment element 19 in the direction of the second conveying direction and the (third) adjustment force generated by the second sensor piston 20 generally urges the adjustment element 19 in the direction of the first conveying direction. Due to the fact that in this exemplary embodiment the high-pressure line 15 as well as the slave cylinder 13 show no and/or only negligibly low leakage, this neutral position is equivalent to a zero position of the pump 10a, in which the pump 10a is adjusted such that no pressure fluid flows/no pressure fluid is conveyed, neither in the first nor in the second conveying direction

The neutral position of the swashplate 19 is preferably supported by a return spring 29, with the return spring 29 acting upon the swashplate 19 such that the swashplate 34 is supported in the neutral position with a certain spring force, at least when the actuator 18 is turned off.

In order to again open the clutch 3 and to actuate the transmission 4, the pump 10a is then brought again into the second pump setting by displacing the adjustment element 19. For this purpose, first the actuator 18 is adjusted such that the adjustment element/the swashplate 19 is brought with its incline into a second position 22. This way the pressure fluid is pumped out of the first high-pressure line 15 via the first fluid connection 8 and the second fluid connection 9 into the second high-pressure line 24. Due to the fact that the pressure value initially is still greater in the first high-pressure line 15 than the pressure value in the second high-pressure line 24, and at first the pressure fluid is taken from the first high-pressure line 15, the pressure value in the second high-pressure line 24 therefore increases and finally exceeds the pressure value in the first high-pressure line 15, the two-pressure valve 26 is adjusted such that the connection between the low-pressure line 16 and the second high-pressure line 24 is severed and the pressure fluid is therefore conveyed via the first high-pressure line 15 out of the retention system 17.

When the pressure value in the second high-pressure line 15 increases, the first sensor piston 20 is retracted and the second sensor piston 27 is extended so that again a resetting of the adjustment element 19 occurs. At a certain pressure value it finally occurs that the neutral position of the adjustment element 19 and/or the pump 10a is reached once more. This way, upon reaching a certain pressure value, the adjustment element 19 is brought into a neutral position in which neutral position the pressure value is kept constant in the second high-pressure line 24.

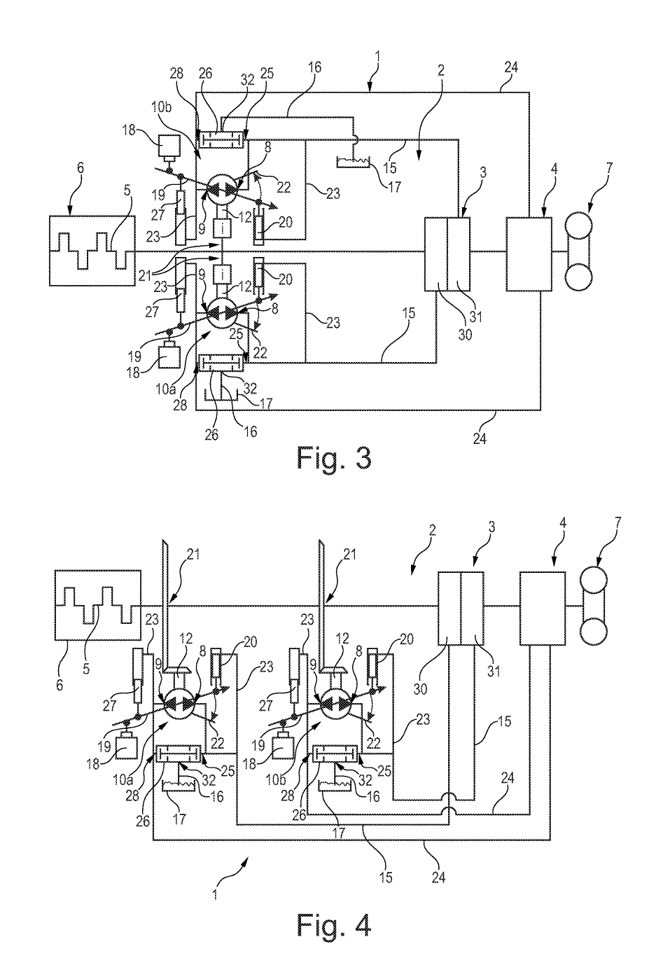

As furthermore discernible in FIGS. 3 and 4, according to a third and fourth embodiment, the actuating device 1 can also be designed as an actuating device for a duplex clutch transmission and a duplex clutch transmission can be integrated therein.

The third embodiment of the actuating device 1 (FIG. 3) comprises, in addition to the pump 10a, another, second pump 10b, which is embodied like the first pump 10a and is connected and operates like it. Consequently, both pumps 10a and 10b are each embodied for operating two actuating pistons 11 via the above-mentioned high-pressure and low-pressure lines 15, 16, and 24. In this embodiment the two pumps 10a and 10b are arranged off-set from each other along the circumference of the motor shaft 5.

The first high-pressure line 15 of the first pump 10a is here connected to an actuator piston in a first partial clutch 30 and the second high-pressure line 24 of the first pump 10a to an actuator piston within the transmission 4. The first high-pressure line 15 of the second pump 10b is connected to an actuator piston in a second partial clutch 31 and the second high-pressure line 24 of the second pump 10b is connected to an actuator piston within the transmission 4.

According to a fourth embodiment shown in FIG. 4 it is also possible to arrange the two pumps 10a and 10b axially offset in reference to each other. In this embodiment the mechanical connection 21 is additionally embodied as a pair of gears, with respectively a first skew gear being connected in a torque proof fashion to the motor shaft 5 and a second skew gear combing the first gear being connected in a torque proof fashion to the pump drive shaft 12. In addition to the skew gears, here other types of gears are also possible, for example spur gears at the two gears.

For reasons of completeness it shall be mentioned that the clutch/clutch device 3 and the respective partial clutches 30 and 31 each exhibit a displaceable pressure plate in the axial direction of the clutch device 1 (axial direction is equivalent to the direction along the rotary axis of the clutch/rotary axis of the clutch). The pressure plate is here cooperating/motion coupled in a conventional fashion to the actuator piston 11 of the actuating device 1. The pressure plate can be moved back and forth between a coupled position, in which position the pressure plate 7 is connected in a torque proof fashion to a clutch disk as well as a counter pressure plate of the clutch device 1 and an idle position, i.e. the disengaged position in which the pressure plate is not connected in a torque-proof fashion but arranged distanced from the clutch disk and the counter pressure plate and no torque being transmitted between the clutch disk and the counter pressure plate/pressure plate.

In other words, by the actuating device 1 according to the invention a clutch actuation is possible with a reversible displacement pump (displacement pump 10a and 10b) connected to the drive, as shown by the example of a single clutch with CSC (Central Slave Cylinder). The pump 10a, 10b is connected to the motor shaft 15 via a mechanical connection 21 comprising an optional transmission. This connection and transmission can for example occur by way of gears, belts, chains, or other connections. Additionally the pump 10a, 10b can rest directly on the motor shaft 15.

The pump 10a, 10b is embodied as a reversible displacement pump 10a, 10b, with its conveying volume being adjustable on the pressure side via a predetermined force using an actuator 18 and a sensor piston 20, 27. A reservoir 17 is connected at the low-pressure side of the pump 10a, 10b in a first embodiment. The high-pressure side is connected to a slave cylinder 13 of a clutch 3. Here, a reversible displacement pump 10a, 10b means that the pump 10a, 10b can adjust its conveying volume by “0”/“zero” and this way at identical direction of rotation of the drive the conveying direction can be reversed. Thus, the amount and the arithmetic sign of the conveying flow is adjusted depending on the actuator 18 and the sensor piston 20, 27.

As an alternative to the design shown here comprising a concentric slave piston/actuator piston 11 and engaging bearings, of course a plurality of other clutch variants are possible as well, such as slave pistons with lever and engaging bearing, rotary passages, etc.

In a second embodiment furthermore the actuation of a partial transmission is possible, comprising a clutch 3 and a transmission 4 with a reversible displacement pump 10a, 10b. The clutch 3 can here be embodied similar to the clutch 3 of the first embodiment, the actuation of the transmission can occur similar to a hydraulic with valves, or be embodied according to the ‘LuK HGA principle”.

The pump 10a, 10b is again connected via gears to the motor shaft 5. The gears are shown angled, however they may also be embodied in a straight fashion or as belt drives etc. The pump 10a, 10b can now generate pressure in two directions in order to either actuate the transmission 4 or the clutch 4. The logic is here controlled with the two-pressure valve 26. Due to the fact that there are now two pressure sides, the pump requires two sensor pistons 20, 27, one for each direction of pressure. The effective principle is analogous to the one of the first embodiment. A return spring 29 can be used in order to pull the pump 10a, 10b into a neutral position when the actuator 18 is shut off.

The third embodiment can implement the actuation of a duplex clutch transmission similar to the second embodiment, but using two pumps 10a and 10b, each of which used to actuate a partial transmission 30, 31.

### LIST OF REFERENCE CHARACTERS

1 Actuating device
2 Drive train
3 Clutch
4 Transmission
5 Motor shaft/crankshaft
6 Internal combustion engine
7 Wheel
8 First fluid connection
9 Second fluid connection
10a First pump/first displacement pump
10b Second pump/second displacement pump
11 Actuating element/actuating piston/first actuating piston
12 Pump drive shaft
13 Slave cylinder
14 Cylinder housing
15 High-pressure line/first high-pressure line
16 Low-pressure line
17 Retention system
18 Actuator
19 Adjustment element/swashplate
20 Sensor piston/first sensor piston
21 Mechanical connection
22 Second position of the adjustment element 19 (equivalent to the second pump position)
23 Secondary channel/Branching
24 Second high-pressure line
25 First input
26 Two pressure valve
27 Second sensor piston
28 Second input
29 Return spring
30 First partial clutch
31 Second partial clutch
32 Output

1. An actuating device for actuating at least one of a clutch or a transmission of a motor vehicle, comprising a pump having first and second fluid connections and a displaceable actuating element connected in a fluid-conducting fashion to the first fluid connection of the pump, with the pump being operable in a first pump setting, in which it is driven in a first direction of rotation, such that a pressure fluid is conveyed in a first conveying direction from the second fluid connection to the first fluid connection to extend an actuating element, the pump is embodied with regards to a direction of conveyance as a reversible displacement pump, with the displacement pump being operable in a second pump setting in which it is driven in the first direction of rotation, such that the pressure fluid is conveyed in a second conveying direction, opposite the first conveying direction, from the first fluid connection to the second fluid connection (9) to retract the actuating element.

2. The actuating device according to claim 1, further comprising at least one of a first high-pressure line which connects the first fluid connection to the actuator element in a fluid-conducting fashion, or a low-pressure line which connects at least one of the first fluid connection or the second fluid connection to a retention system in a fluid-conducting fashion.

3. The actuating device according to claim 2, wherein the first high-pressure line is connected in a fluid-conducting fashion to a first sensor piston, automatically returning the pump into a neutral position at a certain pressure value, with the pump in the neutral position being adjusted such that a fluid pressure in the first high-pressure line is kept constant.

4. The actuating device according to claim 3, further comprising a second high-pressure line which connects the second fluid connection in a fluid-conducting fashion to another, second actuator element.

5. The actuating device according to claim 4, wherein the second high-pressure line is connected in a fluid-conducting fashion to a second sensor piston, automatically returning the pump into a neutral position at a certain pressure value, with the pump being adjusted in the neutral position such that a fluid pressure in the second high-pressure line is kept constant.

6. The actuating device according to claim 5, wherein a force-controlled actuator is provided, adjusting the pump setting of the pump, which together with at least one of the first sensor piston or the second sensor piston acts upon the pump in an adjusting fashion such that the pump setting is dependent on adjustment forces acting upon the pump in an adjusting fashion by at least one of the actuator, the first sensor piston, or the second sensor piston.

7. The actuating device according to claim 6, wherein the actuating element, connected to the first fluid connection of the pump for actuating the clutch and the second actuator element are provided for actuating a transmission.

8. The actuating device according to claim 5, further comprising a two-pressure valve with a first input of the two-pressure valve being connected in a fluid-conducting fashion to the first high-pressure line, a second input of the two-pressure valve being connected to the second high-pressure line, and an output of the two-pressure valve being connected to the low-pressure line.

9. A clutch, comprising an actuating device according to claim 1, wherein the actuator piston connected to the first fluid connection of the pump being provided for engaging and disengaging the clutch.

10. A transmission arrangement with an actuating device according to claim 1.
